(19) United States
(12) Patent Application Publication
(10) Pub. No.: US 2011/0017610 A1
(43) Pub. Date: Jan. 27, 2011

(54) DEVICE AND PROCESS FOR BREAKING DOWN POLLUTANTS IN A LIQUID AND ALSO USE OF SUCH A DEVICE

(76) Inventors: Alexander Hahn, Rottenbach (DE); Jochen Straub, Erlangen (DE); Klaus Strätz, Trunstadt (DE); Manfred Waidhas, Nurnberg (DE)

Correspondence Address: King & Spalding LLP, 401 Congress Avenue, Suite 3200, Austin, TX, 78701, US

(21) Appl. No.: 12/675,832

(22) PCT Filed: Sep. 1, 2008
(86) PCT No.: PCT/EP2008/061501

§ 371 Date: Sep. 16, 2010

(30) Foreign Application Priority Data
Sep. 3, 2007 (DE) 10 2007 041 828.2

(51) Int. Cl. C02F 1/467; C25B 9/00; C25B 11/00; C02F 1/461; C02F 103/28; C02F 103/30

(52) U.S. Cl. 205/746; 204/263; 204/260; 204/264

(57) ABSTRACT

A device (100) for breaking down pollutants in a liquid (F) by oxidative OH radicals has an arrangement of positively and negatively charged electrodes (104a . . . 104n, 105a . . . 105n), wherein at least one of the positively or negatively charged electrodes (104a . . . 104n, 105a . . . 105n) is surrounded by a separator (107) at least in the contact zone between the liquid (F) and the electrode (104a . . . 104n, 105a . . . 105n).

### CROSS-REFERENCE TO RELATED APPLICATIONS

This application is a U.S. National Stage Application of International Application No. PCT/EP2008/061501 filed Sep. 1, 2008, which designates the United States of America, and claims priority to German Application No. 10 2007 041 828.2 filed Sep. 3, 2007, the contents of which are hereby incorporated by reference in their entirety.

### TECHNICAL FIELD

The invention relates to a device, a process and the use of such a device for breaking down pollutants in a liquid, in particular for breaking down pollutants in an aqueous medium.

### BACKGROUND

The pollutants are broken down substantially through the oxidizing action of OH radicals. In order to break down the pollutants, the liquid is treated in a device which has an arrangement of positively and negatively charged electrodes, which are arranged in a container through which the liquid flows. The electrodes are separated from one another, in each case forming a working space. For the purpose of continuous treatment of the liquid, the latter is supplied to the working space by means of a feed and discharge. A device of this type and a process for operating such a device are proposed, for example, in the not previously published application: DE 10 2006 034 895.8 bearing the title: Process for removing pollutants from liquids and device for carrying out the process, dated Jul. 25, 2006.

In the effluents from the paper or pulp industry and also in the printing or textile industry, lignin, resins and humic substances are found. Lignin (Latin: lignum=wood) is understood to mean a phenolic macromolecule. Lignin in wood is a solid, colorless substance which is incorporated in the vegetable cell wall and thus effects the lignification of the cell. Humic substances are generally understood to be weakly brown to black organic substances which are generally formed in humic soils, have no reproducible chemical structure and have different properties and compositions. Lignin and humic substances in the sense of the present invention are understood to be the substantial pollutants in the effluent from the aforementioned industrial sectors.

Industrial effluents of this type have a high COD value (COD=Chemical Oxygen Demand). Such effluents need to be purified before their introduction into the general effluent system.

One possible process for purifying such effluents is the oxidation of the corresponding lignin or humic substances. The oxidation is carried out by introducing ozone (O₃) into the effluent. Following introduction into water, ozone breaks down into OH radicals, which have an oxidizing action.

For the purpose of purifying effluents with ozone, what are known as ozonizers are used. Ozonizers use pure oxygen as starting material and generate ozone by means of a high voltage between 10 kV and 40 kV. Ozonizers have a poor efficiency.

On account of the poor efficiency and the fact that, for industrial processes, pure oxygen is normally used as starting material, the production of ozone with an ozonizer is expensive.

As an alternative to an ozonizer, electrochemical processes exist. By means of such processes, OH radicals are produced directly by an electrochemical route in the liquid to be purified. Electrochemical processes have a considerably higher overall efficiency as compared with ozonizers.

With the not previously published German patent application AZ 10 2006 034 895 from the applicant, bearing the title: “Process for removing pollutants from liquids and device for carrying out the process”, a process for the electrochemical production of OH radicals for the purification of industrial effluents, in particular for purifying the effluents from the paper industry, is proposed. In this process, the liquid to be purified is led through a chamber-like arrangement of alternating positively and negatively charged electrodes. The liquid to be purified is thus in direct contact with the electrodes.

In order to produce OH radicals, a specific quantity of charge is needed, which depends on the type of reaction. In addition, parasitic secondary reactions take place, which limit the efficiency. The power needed for the production of OH radicals is determined as the product of current (A) and voltage (V); the necessary energy in a corresponding way from the product of charge (A·s) and voltage (V).

In the following text, only an examination with respect to the energy is to be carried out.

Of the two parameters current (A) and voltage (V) which determine the energy needed for the OH radical production, only the voltage term can be influenced directly by means of an apparatus structure, since the current term (A), as mentioned above, is predefined by the chemical reaction of the OH radical formation.

The voltage term (V) is determined firstly by the half-reactions taking place at the electrodes. According to Ohm's Law V=RI, the voltage term (V) is, however, also determined by the resistance between the electrodes. The resistance present between the electrodes is in turn dependent on the electrolyte present between the electrodes and the spacing of the electrodes from one another.

The amount of energy for the electrochemical production of OH radicals decreases as the spacing of the electrodes from one another decreases. On account of recombination effects, which counteract the OH radical formation, the spacing of the electrodes cannot be reduced arbitrarily.

### SUMMARY

Taking this as a starting point, according to various embodiments, a device and a process for breaking down pollutants in a liquid can be specified which are improved with regard to the technical problems present in the prior art. In particular, the device and the process are intended to have an improved yield in relation to the electrochemical production of OH radicals.

According to an embodiment, a device for breaking down pollutants in a liquid, in particular for breaking down organic pollutants in an aqueous medium, by means of oxidizing OH radicals, may have—an arrangement of positively and negatively charged electrodes, which are separated from one another, forming a working space and—a feed and discharge, by means of which the working space is accessible to the liquid for the purpose of continuous processing of the latter, wherein—at least one of the positively or negatively charged electrodes, at least in the contact region between the liquid and the electrode, being surrounded by a separator, forming an electrode chamber, which reduces the working space between the electrodes, and wherein—the electrode chamber being filled with a conductive electrolyte.

According to a further embodiment, at least one negatively charged electrode can be surrounded by a separator and the electrode chamber is filled with an alkaline conductive electrolyte. According to a further embodiment, at least one positive electrode can be surrounded by a separator and the electrode chamber is filled with an acid conductive electrolyte. According to a further embodiment, all the positively or all the negatively charged electrodes can be in each case surrounded by a separator. According to a further embodiment, the separator can be fabricated from a microporous material. According to a further embodiment, the electrodes can be formed as plane-parallel surfaces. According to a further embodiment, one of the electrodes and the separator can be formed as hollow cylinders arranged substantially concentrically with respect to each other, and the further electrode is arranged in the center of the hollow cylinders. According to a further embodiment, the electrodes can be surface-structured. According to a further embodiment, the positive electrodes can be formed from MMO (Mixed Metal Oxide) material. According to a further embodiment, the positive electrode can be selected from at least one material from the material group comprising diamond, platinum, silicon carbide, tungsten carbide, titanium carbide, titanium nitrite, titanium carbon nitrite. According to a further embodiment, as the material for a positively charged electrode, consumable material is selected from at least one material from the material group comprising iron, stainless steel alloys, aluminum, aluminum alloys, carbon. According to a further embodiment, the material for a negatively charged electrode can be selected from at least one material from the material group comprising iron, stainless steel alloys, carbon, aluminum. According to a further embodiment, there can be means for electrode cleaning. According to a further embodiment, the means for electrode cleaning can be mechanical wipers/scrapers, ultrasound and/or additions of floating elements in the liquid. According to a further embodiment, there can be a foam separator. According to a further embodiment, a separating device for oxygen and/or hydrogen can be provided.

According to another embodiment, a process for breaking down pollutants in a liquid, in particular for breaking down organic pollutants in an aqueous medium, may comprises the following steps: —continuous feeding of the liquid by means of a feed and discharge into a working space, which is formed between mutually separated, positively and negatively charged electrodes of an arrangement, —electrochemical production of OH radicals in the liquid, at least one of the positively or negatively charged electrodes, at least in the contact region between the liquid and the electrode, being surrounded by a separator, forming an electrode chamber, and the separator reducing the working space between the electrodes, the electrode chamber being filled with a conductive electrolyte, —breaking down pollutants in the liquid by means of OH radicals.

According to a further embodiment, the electrochemical production of the OH radicals can be carried out with a voltage of <5 V. According to a further embodiment, the voltage can be a DC voltage. According to a further embodiment, the process may comprise galvanostatic performance, the current density on the electrode surfaces being between 2 mA/cm² and 500 mA/cm². According to a further embodiment, the DC voltage can be pulsed. According to a further embodiment, the electrochemical production of the OH radicals can be carried out with an alternating current, in particular with an alternating current in the form of a triangular, sinusoidal and/or plateau oscillation, the frequency of the alternating current lying between 10⁻³ Hz and 1 Hz. According to a further embodiment, a COD (Chemical Oxygen Demand) value can be used as a measure of the pollutant concentration and breakdown of the pollutants is measured by using a decline in the COD value. According to a further embodiment, the process may comprise the breaking down of non-biodegradable COD. According to a further embodiment, the process may comprise the generation of biodegradable COD. According to a further embodiment, before the electrochemical treatment of the liquid, mechanical pre-disintegration of solid constituents present in the liquid can be carried out. According to a further embodiment, the liquid can be UV-activated. According to a further embodiment, the process may comprise separation of oxygen arising in the process and use of the oxygen for the activation of biological settling tanks. According to a further embodiment, the pollutants can be primarily organic dyes. According to a further embodiment, the organic dyes can be natural dyes. According to a further embodiment, the organic dyes can be synthetic dyes.

According to yet another embodiments, a device as described above can be used in the paper or pulp industry, the printing or textile industry, to break down lignin or humin in the effluents from the respective industry.

### BRIEF DESCRIPTION OF THE DRAWINGS

Further possible configurations of the device according to various embodiments for breaking down pollutants and also of the process according to various embodiments for breaking down pollutants emerge from the description and also in particular from the highly schematic drawing, in which:

FIG. 1 shows a device for breaking down pollutants in cross section,

FIG. 2 shows such a device in plan view,

FIG. 3 shows a device for breaking down pollutants, configured in the form of a tube, in cross section,

FIG. 4 shows a device for treating water, and

FIG. 5 shows such a device having a foam separator.

In the drawing, corresponding components are provided with the same designations. Parts not explained specifically are generally known prior art.

### DETAILED DESCRIPTION

According to various embodiments: During the electrochemical production of OH radicals in an aqueous environment, the amount of energy needed decreases as the spacing of the electrodes from one another becomes smaller. Recombination effects prevent it from being possible for the plate spacing to be reduced as desired in order to increase the electrochemical chemical yield of OH radicals further. By means of a separator, which can be arranged between the electrodes, recombination effects can be reduced. The electrode reactions themselves, across which a certain voltage term drops, cannot be reduced by a separator, however. In order to reduce the effective electrode spacing, one of the two electrodes, that is to say the positively or negatively charged electrode, is surrounded by a separator in such a way that direct contact of the liquid to be purified with the corresponding electrode is no longer possible. The chamber between the corresponding electrode and the barrier surrounding it is filled with a highly conductive liquid. As a result, the non-reactive voltage drop between the electrode and separator is reduced greatly. In this way, the distance across which the voltage applied between the electrodes drops, i.e. the effective electrode spacing, is able to be reduced to the distance between a separator and the electrode respectively not surrounded by the separator, it being possible for recombination effects to be suppressed at the same time. The electrodes not surrounded by the separator are generally also designated as working electrode.

In the latter connection, a separator is understood to be a body made of a porous or microporous material, it being possible to use as material a hydrophilic polymer or one hydrophilized by means of appropriate surface treatment, such as polypropylene, polytetrafluoroethylene. Furthermore, the separator can consist of glass, glass mesh or nonwoven. The separator can have a pore volume between 25% and 95%, pores not accessible from the surface of the separator (closed porosity) not being taken into account.

According to the various embodiments, with reference to the device, the object is achieved with the following measures. A device for breaking down pollutants in a liquid, in particular for breaking down organic pollutants in an aqueous medium, through the oxidizing action of OH radicals is specified, this device comprising an arrangement of positively and negatively charged electrodes, which are separated from one another, forming a working space. The device further comprises a feed and discharge, by means of which the liquid is fed to the working space for the purpose of continuous processing of the former. At least one of the positively or negatively charged electrodes, in the contact region between the liquid and the electrode, is surrounded by a separator, forming an electrode chamber, the electrode chamber reducing the working space between the electrodes. The electrode chamber is also filled with a conductive electrolyte.

With the aid of the aforementioned measures according to various embodiments, it is possible to achieve an improved efficiency by an electrochemical route, which means that more effective purification of the liquid, in particular the breakdown of pollutants in a liquid, can be achieved. The device thus permits the more cost-effective breaking down of pollutants in the liquid.

Accordingly, the device according to other various embodiments can also have the following features:
At least one negatively charged electrode can be surrounded by a separator, and the electrode chamber can be filled with an alkaline conductive electrolyte. Alternatively, at least one positive electrode can be surrounded by a separator and the electrode chamber can be filled with an acid electrolyte. The breaking down of the pollutants present in the liquid is always carried out at the working electrode, i.e. at that electrode which is not surrounded by a separator. Depending on whether the pollutants present in the liquid are converted by oxidation or reduction, the negatively or the positively charged electrode is correspondingly respectively provided with a separator. According to the aforementioned embodiments, the device can be configured flexibly.
All the positively or all the negatively charged electrodes can be surrounded by a separator. The overall effectiveness of the device can be improved by all the positively or all the negatively charged electrodes being surrounded by a separator.
The separator can be fabricated from microporous material. A separator made of a microporous material prevents the reaction of the liquid to be purified at the relevant electrode surrounded by the separator. The ion conduction is not interrupted by a microporous separator, however, which means that the spacing between the electrodes that is relevant to the voltage drop can be reduced.
The electrodes can be formed as plane-parallel surfaces. If the electrodes are formed as plane-parallel surfaces, then such a construction of the device permits the smallest possible working volume to be achieved, based on the overall volume of the device. In this way, the device can be configured compactly.
One of the electrodes and the separator can be formed as hollow cylinders arranged substantially concentrically with respect to each other; the further electrode can be arranged in the center of the hollow cylinders. According to the above embodiment, it is possible for a closed arrangement for treating the pollutant-containing liquid to be specified, which means in particular that the formation of foam during the treatment of the liquid can be prevented.
The electrodes can be surface-structured. By means of surface structuring of the electrodes, the surface thereof can be enlarged, which leads to an improvement in the effectiveness of the device.
The electrodes can be formed from an MMO material. Furthermore, in particular platinum, silicon carbide, tungsten carbide, titanium carbide, titanium nitrite and/or titanium carbon nitrite can be used. An MMO material is particularly suitable for configuring the electrodes of a device according to the above embodiment.
As the material for a positively charged electrode, use can be made of consumable material such as, in particular, iron, stainless steel alloys, aluminum, aluminum alloys and/or carbon. Furthermore, as the material for a negatively charged electrode, use can be made of iron, stainless steel alloys, carbon and/or aluminum. The aforementioned materials are particularly suitable for configuring a positively charged electrode or a negatively charged electrode.
It is possible for there to be means for electrode cleaning, in particular mechanical wipers/scrapers, ultrasound and/or additions of floating elements in the liquid. Contamination of the electrodes leads to a worsening of the overall efficiency of the device. The efficiency can be improved again by means of cleaning the electrodes. Furthermore, the reliability of the device is improved by electrode cleaning.
It is possible for there to be a separating device for oxygen and/or hydrogen. The overall effectiveness of the device can be improved by means of the recovery of oxygen and/or hydrogen.

With reference to the process, the object is achieved with the following measures: For breaking down pollutants in a liquid, in particular for breaking down organic pollutants in an aqueous medium, the process according to various embodiments may comprise the following steps. The liquid is fed continuously by means of a feed and discharge to a working space, which is formed between the mutually spaced positively and negatively charged electrodes of an arrangement. OH radicals are produced electrochemically in the liquid, at least one of the positively or negatively charged electrodes, in the contact region between the liquid and the electrode, being surrounded by a separator, forming an electrode chamber. The separator reduces the working space between the electrodes; the electrode chamber is filled with a conductive electrolyte. Pollutants which are present in the liquid are broken down by oxidation by means of OH radicals at the positive electrode or by reduction at the negative electrode.

According to various further embodiments, the process can be combined with various features. Accordingly, the process according to various embodiments can additionally have the following features:
The electrochemical production of the OH radicals can be carried out with a voltage of <5 V. As a result of the low voltage, firstly the C efficiency [energetic] increases and, secondly, structures which are easy to maintain and shockproof can be implemented with low voltage. By contrast, ozonizers are high-voltage systems.
The production of the OH radicals is carried out with a DC voltage.
The current density on the electrode surfaces can be between 2 mA/cm² and 500 mA/cm². As a result, the efficiency can be optimized and possibly regulated, depending on the conductive electrolyte and the drive electrolyte.
The DC voltage can be pulsed. The influences of diffusion processes are limited as a result, which means that the liquid transport of the reactants and the elimination of disruptive gas bubbles are reduced.
The electrochemical production of the OH radicals can be carried out with an alternating current, which in particular can have the form of a triangular, sinusoidal and/or plateau oscillation. Furthermore, the frequency of the alternating current can lie between 10⁻³ Hz and 1 Hz. Advantages which result additionally are lifetime prolongations when consumable electrodes are used.
The COD value can be used as a measure of the pollutant concentration; breakdown of the pollutants can be measured by using a decline in the COD value. In particular, the breaking down of non-biodegradable COD can be carried out. Furthermore, biodegradable COD can be generated. A reduction in non-biodegradable COD and/or the generation of biodegradable COD and/or a reduction in the COD value are/is an important objective of effluent purification. Accordingly, a process which changes the COD value in accordance with the above explanations can be employed particularly advantageously.
Before the electrochemical treatment of the liquid, mechanical pre-disintegration of solid constituents present in the liquid can be carried out. As a result of disintegration of solid constituents, faults in the process, for example resulting from blockages, can be avoided. In this way, an increase in the reliability of the process is achieved.
The liquid can be UV-activated. By means of the UV activation, certain electrode reactions can specifically be supported. Selective breakdown or an increase in the efficiency.
Oxygen arising in the process can be separated off and used for the activation of a biological settling tank. As a result of oxygen arising in the process being separated off, this can advantageously be employed for the activation of biological settling tanks without additional oxygen being needed.
The dyes can primarily be organic dyes; the organic dyes can be natural dyes or synthetic dyes. To a large extent, dyes constitute a loading on effluents. A reduction of dyes is therefore particularly advantageous during effluent treatment.

The device according to various embodiments can be used in particular in the paper or pulp industry, the printing or textile industry, to break down lignin or humin in the industrial effluents.

In the aforementioned industries, lignin or humin constitutes an essential constituent part of the effluent contamination. Use of the device according to various embodiments or one of its developments is therefore particularly advantageous.

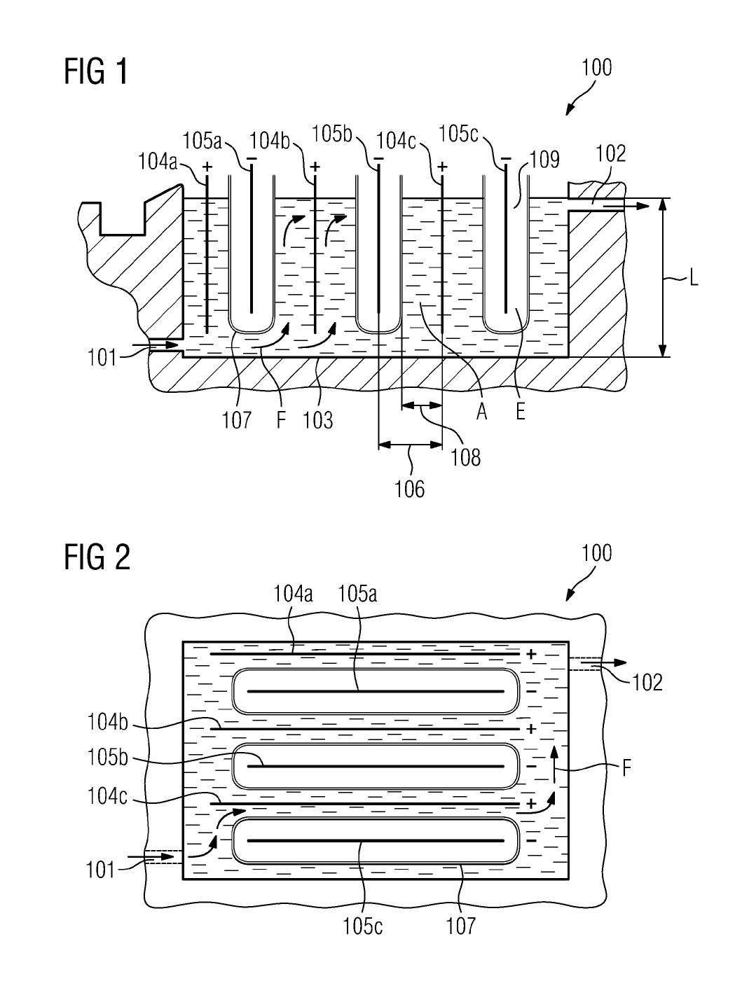

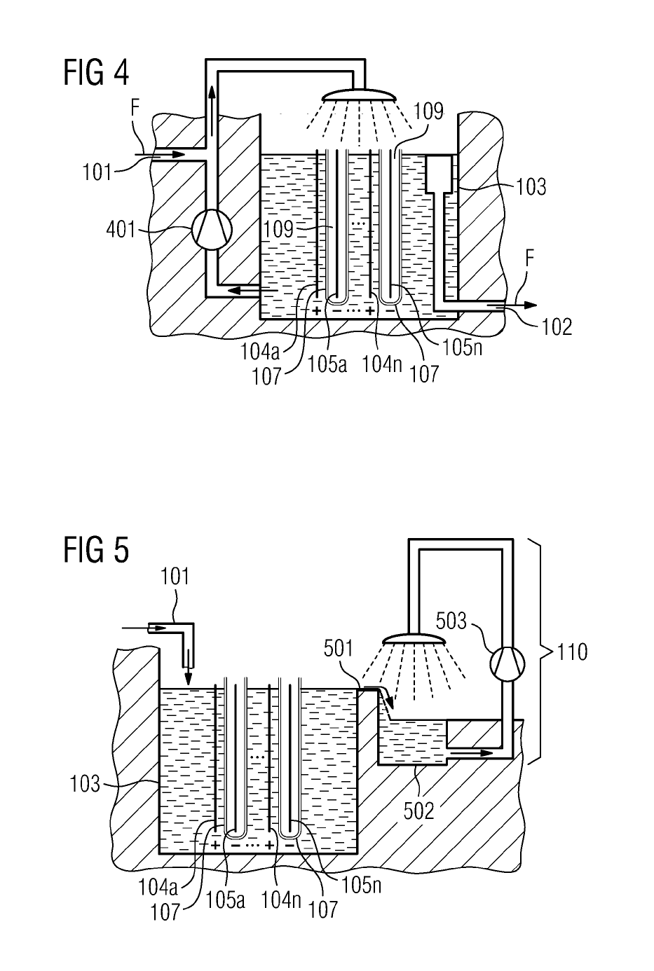

FIG. 1 shows an only partly explained device 100 for breaking down pollutants in a liquid, in particular for breaking down organic pollutants in an aqueous medium. Further details relating to the device 100 are indicated in FIG. 4. The device 100 is illustrated in cross section in FIG. 1. A liquid to be purified is fed via a feed 101 to a container 103, which the liquid F leaves again via the discharge 102. The flow of the liquid F within the container 103 is to some extent indicated by arrows. The container 103 can be filled with the liquid F to be purified only as far as the height L. Within the container 103 there is an arrangement of positively charged electrodes 104a to 104c and negatively charged electrodes 105a to c. The electrodes can in particular be configured as plates oriented plane-parallel to one another. Between the electrodes 104a to 104c, 105a to 105c there is a working space A, the width of which is determined by the electrode spacing 106.

At least one negatively charged electrode 105, preferably some of the negatively charged electrodes 105 or, furthermore, preferably all the negatively charged electrodes 105a . . . c are surrounded in the same way by a separator 107. The separator 107 surrounds the negative electrodes 105a . . . c completely in such a way that no direct contact is possible between the liquid F to be purified present in the container 103 and the actual electrode 105a . . . c. The separator 107 surrounds the electrodes 105a . . . c, in particular in a contact region predefined by the height L of the liquid F in the container 103.

The separator 107, which can in particular be fabricated from a microporous material, reduces the size of the working space (A) between the electrodes 104a . . . 104c and 105a . . . 105c as a result of the fact that the electrode spacing 106 is reduced to an effective electrode spacing 108. The separator 107 surrounds the electrodes 105a . . . 105c, forming an electrode chamber 109. The electrode chamber 109 is filled with a highly conductive electrolyte E. According to the embodiment shown in FIG. 1, in which the electrodes 105a . . . 105c surrounded by the separator 107 are negatively charged, this is an alkaline conductive electrolyte E. Between the alternately charged electrodes 104a . . . 104c and 105a . . . 105c, an electric voltage of less than 5 V is typically applied.

Within the liquid F to be purified which is located within the container 103, water is decomposed electrolytically at the positive electrode in accordance with the equation

H₂O→H⁺+OH^{*}+e⁻ (1)

At the positively charged electrodes 104a . . . 104c, the electrolytic decomposition of water with the production of OH radicals takes place in accordance with the above equation 1. The electrons (e⁻) are transported away via the positively charged electrodes 104a . . . 104c.

The H⁺ ions are transported away by means of ion conduction. In the process, the H⁺ ions pass the microporous separator 107 unhindered, and reach the negatively charged electrodes 105a . . . 105c.

The microporous separator 107, according to the exemplary embodiment shown in FIG. 1, is configured in such a way that mixing of the liquid F to be purified located in the container 103 in the region of the negatively charged electrodes 105a . . . 105c can be avoided. However, ion conduction to the correspondingly negatively charged electrodes 105a . . . 105c can take place without hindrance. The microporous separator 107 also hinders recombination effects, since N₂ does not pass directly from the negative electrode to the positive. Furthermore, no O₂ or OH arising on the positive side is able to depolarize the negative electrode either.

The electric conductivity of a liquid F to be purified is generally of the order of magnitude of a few mS (e.g. between 1 and 10 mS) and is typically 4 mS. The electrode chamber 109 is filled with a highly conductive electrolyte E, which typically has an electric conductivity higher by several orders of magnitude, for example of 1000 mS. The drop in the voltage applied to the electrodes 104a . . . 104c and 105a . . . 105c of typically less than 5 V consequently takes place not across the electrode spacing 106 but across the effective electrode spacing 108, which is determined by the spacing of the separator 107 from the positively charged electrode 104a . . . 104c.

As a result of the processes described above, an increased concentration of OH radicals builds up in the region of the positively charged electrodes 105a . . . 105c. The OH radicals develop an oxidizing action on the pollutants present in the liquid F and in this way promote their breakdown. Those electrodes, specifically the positively charged electrodes 105a . . . c in the exemplary embodiment illustrated in FIG. 1, will be designated working electrodes below, since the breaking down of the pollutants present in the liquid F takes place in the region of these electrodes. With reference to the overall device, oxidative conversion of the pollutants takes place in accordance with the exemplary embodiment shown in FIG. 1.

As an alternative to the exemplary embodiment shown in FIG. 1, a device for breaking down pollutants in a liquid F in accordance with the same principle can be constructed analogously in such a way that the polarization of the negatively and positively charged electrodes is exchanged. In this case, reductive conversion of the pollutants would be carried out. According to such an exemplary embodiment, not illustrated in FIG. 1, the electrodes illustrated in FIG. 1 as positively charged electrodes 104a . . . c would then be negatively charged, and the electrodes 105a . . . c illustrated in FIG. 1 as negatively charged electrodes would be positively charged.

The above-described process is designated reductive conversion.

In this case, there are no OH radicals and there is no oxidative conversion. The breaking down is carried out reductively, which means:
The carbon molecules are reduced to methane (CH4) in the extreme case and normally less probably escape.
Methanol (CH₃OH) or ethanol (C₂H₅OH) groups are split up reductively and either partly escape, that is they evaporate, or else are very easily biodegradable. As a result, the generation of BOD occurs, e.g. in the case of carboxyl groups

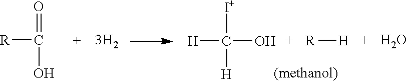

Long-chain molecules are broken apart reductively, i.e. the generation of BOD occurs.

In the aforementioned processes of the oxidative or reductive conversion of pollutants which are present in the liquid F, it is possible for foam formation to occur in a device 100. For this purpose, a device of this type, as shown in FIG. 1, can have a foam separator 110.

FIG. 2 shows a device 100 for breaking down pollutants in a liquid F in plan view. The flow of the liquid F in the device is to some extent indicated by arrows.

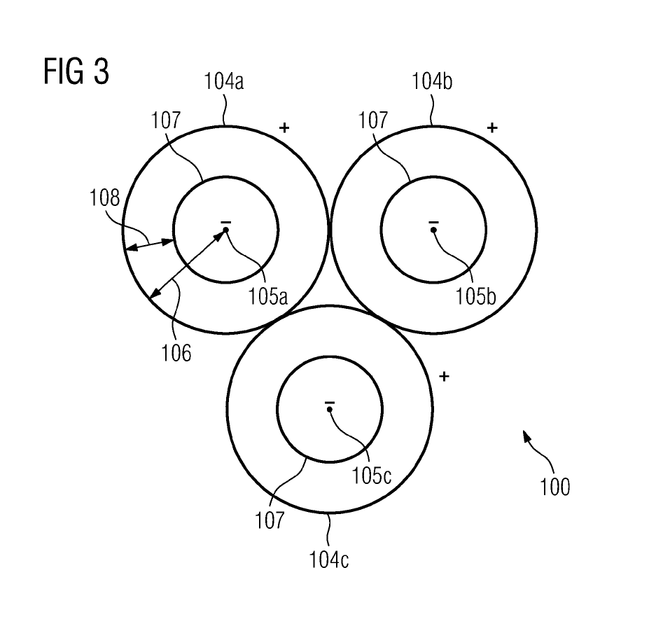

FIG. 3 shows a device 100 for breaking down pollutants in a liquid F in cross-sectional view, at least one electrode and one separator 107 being configured in the form of tubes. Thus, the positively charged electrodes 104a . . . 104c and the corresponding separators 107 can be formed as hollow cylinders arranged substantially concentrically with respect to each other, the negatively charged electrodes 105a . . . 105c in each case being located substantially in the center of the associated hollow cylinders. According to the exemplary embodiment shown in cross section in FIG. 3, the device 100 for breaking down pollutants can be a closed arrangement, which is fed with the liquid F to be purified via a feed and discharge. By means of such a closed arrangement, in particular the formation of foam during the process execution can be reduced.

All the aforementioned exemplary embodiments can be developed subsequently with the measures cited below.

For instance, the electrodes can be surface-structured in order to enlarge their surface. Furthermore, the electrodes can be formed from an MMO material (Mixed Metal Oxide). Furthermore, for example, diamond, platinum, silicon carbide, tungsten carbide, titanium carbide, titanium nitrite and/or titanium carbon nitrite can be used for the construction of the positively charged electrodes 104a . . . 104c. In particular, positively charged electrodes 104a . . . 104c can be formed of consumable material such as in particular iron, stainless steel alloys, aluminum, aluminum alloys and/or carbon. The negatively charged electrodes 105a . . . 105c can be fabricated in particular from iron, stainless steel alloys, carbon and/or aluminum.

A device 100 for breaking down pollutants according to one of the exemplary embodiments shown in FIGS. 1 to 3 can furthermore be provided with means for electrode cleaning. For instance, mechanical wipers or scrapers are suitable as means for electrode cleaning. Alternatively or additionally, cleaning of the electrodes can be carried out by means of ultrasound. Likewise possible is cleaning of the electrodes via floating elements present in the liquid F to be purified.

FIGS. 4 and 5 show devices from which the working sequence during water treatment can be seen. Thus, FIG. 4 shows a device which has a container 103 in which n electrodes are arranged plane-parallel to one another. In each case alternating in the container 103 there are n positively charged electrodes 104a . . . 104n and n negatively charged electrodes 105a . . . 105n. The negatively charged electrodes 105a . . . 105n are in each case surrounded by a separator 107. A liquid F to be purified is fed to the container 103 through a feed 101; the purified liquid F leaves the container 103 via the discharge 102. The liquid F to be purified located in the container 103 is additionally circulated by a circulating pump 401 and a distributor similar to a shower above the electrode device, in such a way that uniform coverage of the electrodes is ensured. In this connection, suitable measures have to be taken such that the liquid F to be purified does not mix with the highly conductive electrolyte E located within the electrode chamber 109.

FIG. 5 shows a further device, which has a foam separator 110. For this purpose, the container 103 has a run-off edge 501 for foam separation. In a collecting container 502 arranged downstream, the foam separated off in this way is handled by a further circulating pump 103 in a further circuit.

In the following text, further possible configurations of a process for breaking down pollutants in a liquid F in accordance with various exemplary embodiments will be explained. For instance, the electrochemical production of the OH radicals can be carried out with a voltage of less than 5 V. Furthermore, the voltage for the production of the OH radicals can be a DC voltage. Furthermore, this DC voltage can be pulsed. Alternatively, the electrochemical production of OH radicals can be carried out with an alternating voltage. This alternating voltage can in particular have the form of a triangular, sinusoidal and/or plateau oscillation having a frequency between 10⁻³ Hz and 1 Hz. In general terms, the process for OH radical production can be carried out galvanostatically, it being possible for the current density on the electrode surfaces to be between 2 mA/cm² and 500 mA/cm².

The breakdown of pollutants can be measured by using the COD value (Chemical Oxygen Demand) as a measure of the pollutant concentration. Furthermore, it is possible to carry out in particular the breakdown of non-biodegradable COD and the generation of biodegradable COD.

Before electrochemical treatment of the liquid F to be purified, mechanical pre-disintegration of solid constituents possibly present in the liquid F can be carried out. Furthermore, the liquid F can be UV-activated. Oxygen and/or hydrogen arising during the process can be used for further processes. For instance, by means of the oxygen arising, which can be separated off from the process, a biological settling tank can be activated. The pollutants present in the liquid F to be purified can be, in particular, organic dyes. These organic dyes can be natural or synthetic dyes.

The aforementioned process according to one of the exemplary embodiments and the aforementioned device according to one of the exemplary embodiments can be used in particular in the paper or pulp industry and/or the printing or textile industry to break down lignin or humin in the industrial effluents.

What is claimed is:

1. A device for breaking down pollutants in a liquid by means of oxidizing OH radicals, comprising
an arrangement of positively and negatively charged electrodes, which are separated from one another, forming a working space,
and
a feed and discharge, by means of which the working space is accessible to the liquid for the purpose of continuous processing of the latter,
wherein
at least one of the positively or negatively charged electrodes, at least in the contact region between the liquid and the electrode, being surrounded by a separator, forming an electrode chamber, which reduces the working space between the electrodes,
And wherein
the electrode chamber being filled with a conductive electrolyte.

2. The device for breaking down pollutants according to claim 1, wherein at least one negatively charged electrode is surrounded by a separator and the electrode chamber is filled with an alkaline conductive electrolyte.

3. The device for breaking down pollutants according to claim 1, wherein at least one positive electrode is surrounded by a separator and the electrode chamber is filled with an acid conductive electrolyte.

4. The device for breaking down pollutants according to claim 1, wherein all the positively or all the negatively charged electrodes are in each case surrounded by a separator.

5. The device for breaking down pollutants according to claim 1, wherein the separator is fabricated from a microporous material.

6. The device for breaking down pollutants according to claim 1, wherein the electrodes are formed as plane-parallel surfaces.

7. The device for breaking down pollutants according to claim 1, wherein one of the electrodes and the separator are formed as hollow cylinders arranged substantially concentrically with respect to each other, and the further electrode is arranged in the center of the hollow cylinders.

8. The device for breaking down pollutants according to claim 1, wherein the electrodes are surface-structured.

9. The device for breaking down pollutants according to claim 1, wherein the positive electrodes are formed Mixed Metal Oxide (MMO) material.

10. The device for breaking down pollutants according to claim 9, wherein the positive electrode is selected from at least one material from the material group consisting of diamond, platinum, silicon carbide, tungsten carbide, titanium carbide, titanium nitrite, and titanium carbon nitrite.

11. The device for breaking down pollutants according to claim 1, wherein, as the material for a positively charged electrode, consumable material is selected from at least one material from the material group consisting of iron, stainless steel alloys, aluminum, aluminum alloys, and carbon.

12. The device for breaking down pollutants according to claim 1, wherein the material for a negatively charged electrode is selected from at least one material from the material group consisting of iron, stainless steel alloys, carbon, and aluminum.

13. The device for breaking down pollutants according to claim 1, comprising means for electrode cleaning.

14. The device for breaking down pollutants according to claim 13, wherein the means for electrode cleaning are at least one of mechanical wipers/scrapers, ultrasound, and additions of floating elements in the liquid.

15. The device for breaking down pollutants according to claim 1, comprising foam separator.

16. The device for breaking down pollutants according to claim 1, comprising a separating device for oxygen (O₂) and/or hydrogen (H₂).

17. A process for breaking down pollutants in a liquid comprising the following steps:
continuous feeding of the liquid by means of a feed and discharge into a working space, which is formed between mutually separated, positively and negatively charged electrodes of an arrangement,
electrochemical production of OH radicals in the liquid, at least one of the positively or negatively charged electrodes, at least in the contact region between the liquid and the electrode, being surrounded by a separator, forming an electrode chamber, and the separator reducing the working space between the electrodes, the electrode chamber being filled with a conductive electrolyte,
breaking down pollutants in the liquid by means of OH radicals.

18. The process according to claim 17, wherein the electrochemical production of the OH radicals is carried out with a voltage of <5 V.

19. The process according to claim 17, wherein the voltage is a DC voltage.

20. The process according to claim 17, comprising galvanostatic performance, the current density on the electrode surfaces being between 2 mA/cm² and 500 mA/cm².

21. The process according to claim 19, wherein the DC voltage is pulsed.

22. The process according to claim 17, wherein the electrochemical production of the OH radicals is carried out with an alternating current or an alternating current in the form of a triangular, sinusoidal and/or plateau oscillation, the frequency of the alternating current lying between 10⁻³ Hz and 1 Hz.

23. The process according to claim 17, wherein a Chemical Oxygen Demand (COD) value is used as a measure of the pollutant concentration and breakdown of the pollutants is measured by using a decline in the COD value.

24. The process according to claim 23, comprising the breaking down of non-biodegradable COD.

25. The process according to claim 23, comprising the generation of biodegradable COD.

26. The process according to claim 17, wherein, before the electrochemical treatment of the liquid, mechanical pre-disintegration of solid constituents present in the liquid is carried out.

27. The process according to claim 17, wherein the liquid is UV-activated.

28. The process according to claim 17, comprising separation of oxygen (O₂) arising in the process and use of the oxygen (O₂) for the activation of biological settling tanks.

29. The process according to claim 17, wherein the pollutants are primarily organic dyes.

30. The process according to claim 29, wherein the organic dyes are natural dyes.

31. The process according to claim 29, wherein the organic dyes are synthetic dyes.

32. A method of using a device according to claim 1 in the paper or pulp industry or the printing or textile industry, comprising the step of breaking down lignin or humin in the effluents from the respective industry.
